(19) United States
(12) Patent Application Publication
(10) Pub. No.: US 2014/0214701 A1
(43) Pub. Date: Jul. 31, 2014

(54) SYSTEM AND METHOD FOR PROVIDING LEGAL CITATIONS

(71) Applicant: Nick Buzzy, Hudson, OH (US)

(72) Inventor: Nick Buzzy, Hudson, OH (US)

(21) Appl. No.: 14/148,619

(22) Filed: Jan. 6, 2014

Related U.S. Application Data
(60) Provisional application No. 61/748,996, filed on Jan. 4, 2013.

(51) Int. Cl. G06Q 50/18; G06Q 10/10

(52) U.S. Cl. CPC G06Q 50/18; G06Q 10/10
USPC 705/311

(57) ABSTRACT

A system and method for enabling law students and lawyers to correctly format legal citations used in legal documents by accessing a web-application and choosing the format and type of legal source desired. After filling in the components of the citation, the present invention transforms the data real-time into the correct citation. These citations can be imported into legal documents, edited in the future, saved into custom citation libraries, and shared with other users. These functions provide greater flexibility and accuracy in the creation of legal citations and results in a custom database for users that can be access anywhere and at any time.

### CROSS-REFERENCE TO RELATED APPLICATION

This application claims priority to and hereby incorporates by reference, provisional patent application 61/748,996, filed Jan. 4, 2013.

### BACKGROUND OF THE INVENTION

1. Field of the Invention

The present systems and methods relate generally to the provision of correct legal citations for law students' and lawyers' legal documents and also helps manage those legal sources. The present invention interactively formats citations depending on the format selected by the user (Bluebook, ALWD, or state issued citation formats) and the type of legal source formatted (court case, statute, law review, etc.). In addition, the present invention allows users to save these correctly formatted citations into individual folders created by the user which can range from classes to cases assigned to the law student or lawyer.

The purpose of the present invention is to help law students and lawyers save time formatting citations, and also to have an easily accessible database of previously used citations to save time and money from having to re-research the same legal sources. The present invention enables law students and lawyers to spend less time deciphering citation manuals that are hundreds of pages long (which can lead to inconsistent results) or having to go through hundreds or thousands of old documents to find previously used relevant legal citations. The present invention gives users a mobile legal library with an opportunity to reallocate valuable time to crafting legal arguments and other more pressing needs.

2. Prior Art

Automated legal citation systems have been slowly replacing the system of manual citing since the widespread use of the personal computer in the 1990's. There are numerous systems described in patents and currently available software packages which attempt to present an optimized automated legal citation system but each are lacking and have failed to meet the need in the legal market for a system that allows for easy searching, sharing and correction of legal citations.

CiteGenie is an add-on for Firefox web browser that allows users to copy text from legal source websites LexisNexis and Westlaw. When the user pastes the text into Word, CiteGenie provides Bluebook citation format in the document. While CiteGenie does provide citation help, it is browser based and is not accessible via the cloud. In addition there is no tracking mechanism of the citations formatted—a user cannot save citations to a library nor can he or she even view previously used citations. CiteGenie also offers no flexibility in terms of the citations generated. There is no option for explanatory parentheticals, parallel citations as BuzzyCite offers. Instead, CiteGenie formats citations solely in Bluebook format and the user has no control on how the citations turn out. Citations generated by CiteGenie cannot be sent to other CiteGenie users.

Citrus is a program downloaded onto a user's Windows computer to automate correct citations for Word documents. Like CiteGenie, Citrus is machine-based and is not accessible via the cloud. A user presses F2 while Word is opened when a citation is beginning to be written and F2 again once the citation is finished. At that point, Citrus automatically formats the citation to Bluebook format. As with CiteGenie, Citrus offers no flexibility for the citations generated, the results are solely Bluebook format and there are no options for explanatory parentheticals or parallel citations. These citations cannot be saved to custom libraries and cannot be sent to other Citrus users.

Lexis for Microsoft Office is a program that is nearly identical to Citrus's program. It is a machine based program downloaded onto a Windows computer which automates correct citations after a citation is typed. This program is not accessible via the cloud and there are no custom libraries or ability to send citations generated to other users. There is no flexibility with the citations generated and the citations are limited to Bluebook format.

WestlawNext is a program that allows a user to copy text from WestlawNext and paste it into a word document in the desired citation format (Bluebook, ALWD, and a few local rules (not Ohio)). This citation formatting program is also not cloud-based and the individual citations cannot be saved via the cloud. While WestlawNext does allow users to save documents to user-created folders, this library functionality is not based on citations generated. As with all other citation software, WestlawNext offers no flexibility on the citations generated. Parallel citations are automatically generated and explanatory parentheticals must be added by the user.

U.S. Pat. No. 7,028,259 discloses a citation checker plug-in for Microsoft Word. It locates a legal citation within the word document, identifies an error and displays a screen with a proposed change with the correct legal citation format. A user can either accept the suggestion or deny it. U.S. patent application Ser. No. 11/849,918 discloses a citation checker that is also a plug-in for Word. It identifies citations within documents and offers a solution similar to U.S. Pat. No. 7,028,259. A user can either accept or deny the proposed change. It does offer flexibility for parallel citations and explanatory parentheticals. There is an ability to create a table of authorities, but this is imported into the Word document and not a database for future use (constituting a library). U.S. Pat. No. 8,219,566 discloses another Word application that checks documents of citations then offers the correct citation if available.

U.S. Pat. No. 7,844,899 discloses a system which determines the citation method (Bluebook, ALWD, local rules) based on what a user types in. It applies for both Word processers and networks. The system applies the rules of the citation method recognized by the system and converts the citation into that format.

U.S. Pat. No. 8,082,241 discloses a system which scans a document to search for unformatted legal citations. Once the systems finds an unformatted legal citation, it then a lists possible correct citations and the user selects the desired citations. The system does offer the opportunity to create a library, but the library exists only on the machine and is not accessible via the cloud/web.

U.S. patent application Ser. No. 11/532,378 discloses a system which seems to be directly tied to the Citrus system explained above. It corrects citations after the user pushes a button before beginning to type the citation and pushing a button after finishing to type the citation.

One of the major downfalls of each of these prior art systems is that their automation is flawed by being too narrowly linked to pure syntax and errors often arise from those citations which fall into a previously undefined exception. None of these systems in the prior art disclose a system which provides consistently correct legal citations supported by a network of users. Accordingly, creating a system and method that allows for easy searching, sharing and correction of legal citations would be highly useful to lawyers and law students.

### BRIEF DESCRIPTION OF DRAWINGS

The claimed subject matter is described with reference to the accompanying drawings. The accompanying drawings depict multiple embodiments of the claimed system and method. A brief description of each figure is provided below. Elements with the same reference number in each figure indicate identical or functionally similar elements. Additionally, the left-most digit(s) of a reference number indicate the drawing in which the reference number first appears.

FIG. 1 is a diagram of an exemplary basic system showing the functionality of the present invention.

FIG. 2 is an exemplary datamap.

### DETAILED DESCRIPTION

Systems and methods described herein enables law students and lawyers to correctly format legal citations used in legal documents by accessing a web-application and choosing the format and type of legal source desired. After filling in the components of the citation, the present invention transforms the data real-time into the correct citation. These citations can be imported into legal documents, edited in the future, saved into custom citation libraries, and shared with other users. These functions provide greater flexibility and accuracy in the creation of legal citations and results in a custom database for users that can be access anywhere and at any time.

The first problem the present invention addresses is providing correct legal citations used in legal documents. Whenever a law student or lawyer is writing a document and wants to refer to a court case, statute, law review, book, etc., he or she must cite that legal source. Unfortunately for the law student and lawyer, there are numerous different citation formats that he or she must be familiar with. For example, a law student may have to follow Bluebook citation format for a paper in a research and writing class while also following Ohio citation format for a memo to an associate at a law firm. Citation formats vary both in length and content, which further leads to law students and lawyers sacrificing valuable time to have to consistently refer to citation manuals to decipher how to format the legal source for the document.

Incorrect legal citations can result in numerous problems. An intern or new associate can hurt his or her credibility by filing documents with incorrect citations. This can lead to more time revising the document or being reprimanded by his or her superior. Worse, incorrect legal citations can also prevent those reading the legal document from finding the court case, statute, etc. The danger is that the individual reading the document completely discounts whatever was attempted to be cited which could be fatal to the legal argument being made.

The present invention solves this problem by eliminating the need to constantly refer to different citation formats for different legal sources. The web-application allows the user to select what citation format they are citing (Bluebook, ALWD, or other state formats) as well as the type of legal source they are formatting (court case, statute, law review, etc.)1. After selecting the type of format and source, the user selects the citation engine desired to make the citation. If the user is citing a case from the Supreme Court then the user simply clicks on Supreme Court. At that point, the user is directed the Supreme Court page for the given citation format. The user then types in the components of the citations: the parties, the reporter volume number, the reporter, the first page of the citation, the pages cited, and the year of the decision.

The different components of the citation engine have different rules depending upon the format and type of source. For instance, when a user clicks first party he or she has to decide if the party is a person, place, or organization because formatting rules differ between each of the three options. Once a user selects an option then the citation engine formats the first party by following citation rules of the given format in terms of abbreviations, spacing, and capitalization. The party components as well as the remaining components are uniquely coded to properly adhere to the format and source selected by the user. The user only has to put in basic information easily found from the source being cited and the present invention does the rest. If a user wants to add additional information to the citation such as a parallel citation, or an explanatory parenthetical, he or she only has to select that option and put in the additional information. These features give the present invention an interactive and flexible solution to providing custom and correct citations to users.

After each component is filled, the user pushes the Cite Now button and the present invention produces the citation in the correct format on the web-application. Another option besides for using the citation engines is for the user to search for a case or other source to see if it has already been formatted by the present invention. If the source is in the present invention's database, then the user does not need to fill in any inputs, and can retrieve the correctly formatted citation after typing in only a few letters. At this point the user can import the citation into the legal document where the citation is being used, and the user can also save this citation to a library, which leads to the next problem that the present invention addresses.

Traditionally, citations can only be found by users solely in legal documents for which they are used. Over the course of three years of law school and many years in practice, these citations become more and more difficult to find. Most law students and lawyers are forced to search through old case files or documents to find important citations to use for current papers or cases. Even when previously written documents are found, the context and purpose of the citations used can be difficult to remember. The result is law students and lawyers having to re-research the same legal sources previously found on expensive legal source websites such as LexisNexis and Westlaw.

The present invention allows the citations to be saved to one location that can be accessed on the cloud anywhere there is an internet connection. These citations can be saved in libraries organized by law classes, clients, and/or cases, etc. The process of saving a citation to library begins after a user formats a citation through a citation engine or finds the citation via the search engine. At that point, the user can either save the citation to a new library or an existing library. These libraries offer numerous functions to allow law students and lawyers to better organize their legal sources. The present invention libraries allow users to record notes on the citations used, and organize citations by date, type, and alphabetically. With the present invention, law students and lawyers no longer need to search old files or document folders to find previously used citations, which results in time-savings, eliminates the cost of unnecessary online searches, and also increases the amount of legal knowledge available at any one moment.

The present invention's library function also allows users to share/send citations and libraries with other law students and lawyers which can then be added to their libraries. A law student who is part of a legal journal or moot court team can share an important citation with a fellow journal member or teammate or a lawyer who is working with other associates on a bankruptcy case can share a previously used library for a similar case to save time and money from re-researching those same legal sources.

Finally the present invention allows users to find the most recent citations formatted. Law students and lawyers can access the most recent citations without even having to go through created libraries.

As appreciated by one of skill in the art, the present system and method in certain aspects is embodied as a method, data processing system and/or computer program product. Accordingly, the present invention may take the form of an entirely hardware embodiment with logic embedded in circuitry, an entirely software embodiment with logic operating on a general purpose computer to perform, or an embodiment combining software and hardware aspects. Furthermore the system and method in some aspects takes the form of a computer program product on a computer-readable storage medium having computer readable program code means embodied in the medium. Any suitable computer readable medium may be utilized including hard disks, CD-ROMs, optical storage devices, static or nonvolatile memory circuitry, or magnetic storage devices and the like.

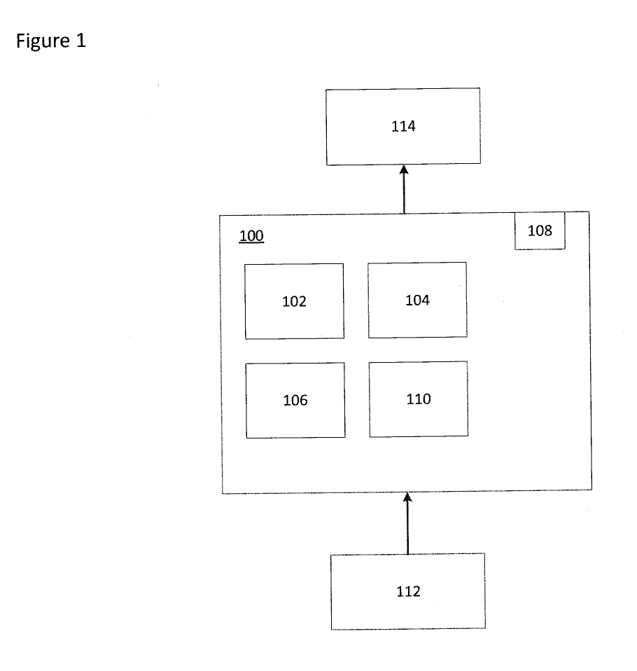

FIG. 1 depicts an exemplary computer system 100, which can be used in implementation of the system and method. The computer system can be a laptop, desktop, server, handheld device (e.g., personal digital assistant (PDA), smartphone), programmable consumer electronics or programmable industrial electronics.

As illustrated the computer system includes a processor 102, which can be any various available microprocessors. For example, the processor can be implemented as dual microprocessors, multi-core and other multiprocessor architectures. The computer system includes memory 104, which can include volatile memory, nonvolatile memory or both. Nonvolatile memory can include read only memory (ROM) for storage of basic routines for transfer of information, such as during boot or start-up of the computer. Volatile memory can include random access memory (RAM). The computer system can include storage media 106, including, but not limited to magnetic or optical disk drives, flash memory, and memory sticks.

The computer system incorporates one or more interfaces, including ports 108 (e.g., serial, parallel, PCMCIA, USB, FireWire) or interface cards 110 (e.g., sound, video, network, etc.) or the like. In embodiments, an interface supports wired or wireless communications. Input is received from any number of input devices 112 (e.g., keyboard, mouse, joystick, microphone, trackball, stylus, touch screen, scanner, camera, satellite dish, another computer system and the like). The computer system outputs data through an output device 114, such as a display (e.g. CRT, LCD, plasma . . . ), speakers, printer, another computer or any other suitable output device.

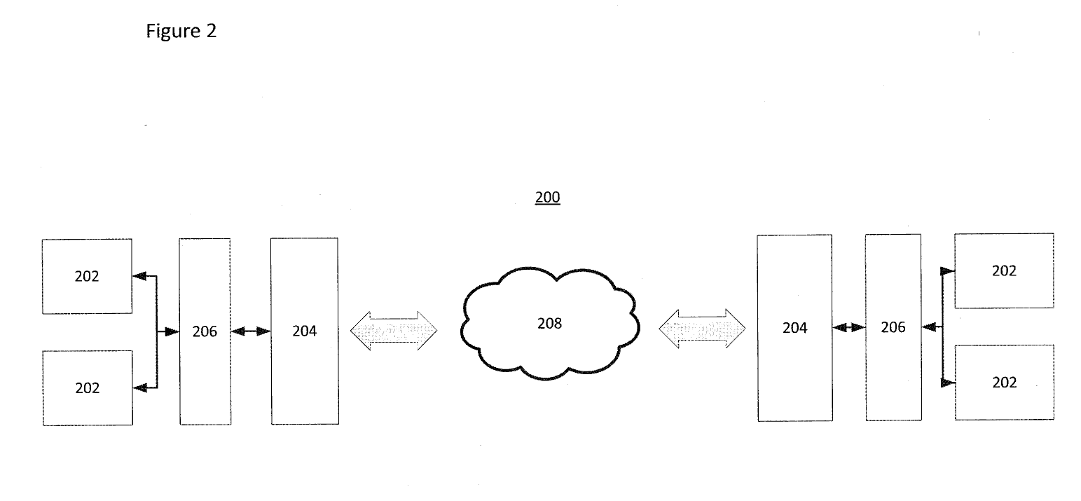

FIG. 2 depicts an exemplary computing environment 200 for implementing the system and method. The computing environment 200 includes one or more clients 202, where a client may be hardware (e.g., personal computer, laptop, handheld device or other computing devices) or software (e.g., processes, or threads). The computing environment 200 also includes one or more servers 204, where a server is software (e.g., thread or process) or hardware (e.g., computing devices), that provides a specific kind of service to a client. The computing environment 200 can support either a two-tier client server model as well as the multi-tier model (e.g., client, middle tier server, data server and other models). In embodiments, the protocol system is a client or hosted by a client device, and the central system is a server, or is hosted on a server.

The computing environment 200 also includes a communication framework 206 that enables communications between clients 202 and servers 204. In an embodiment, clients 202 correspond to local area network devices and servers are incorporated in a cloud 208 computing system. The cloud 208 is comprised of a collection of network accessible hardware and/or software resources. The environment can include client data stores that maintain local data and server data stores that store information local to the servers, such as the module library.

The present invention is described below with reference to flowchart illustrations of methods, apparatus (systems) and computer program products. It will be understood that each block of the flowchart illustrations, and combinations of blocks in the flowchart illustrations, can be implemented by computer program instructions. These computer program instructions may be loaded onto a computer or other programmable data processing apparatus or otherwise encoded into a logic device to produce a machine, such that the instructions which execute on the computer or other programmable data processing apparatus create means for implementing the functions specified in the flowchart block or blocks. These computer program instructions may also be stored in a computer readable memory that can direct a computer or other programmable data processing apparatus to function in a particular manner, such that the instructions stored in the computer readable memory produce an article of manufacture including instruction means which implement the function specified in the flowchart block or blocks. The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

As appreciated by those of ordinary skill in the art, specific functional blocks presented in relation to the present system and method are programmable as separate modules or functional blocks of code. These modules are capable of being stored in a one or multiple computer storage media in a distributed manner. In another aspect, these modules are executed to perform in whole or in part the present system and method on a single computer, in another aspect multiple computers are used to cooperatively execute the modules, and in yet another exemplary aspect the programs are executed in a virtual environment, where physical hardware operates an abstract layer upon which the present system and method is executed in whole or in part across one or more physical hardware platforms.

### CONCLUSION

While various embodiments of the present system and method have been described above, it should be understood that the embodiments have been presented by the way of example only, and not limitation. It will be understood by those skilled in the art that various changes in form and details may be made therein without departing from the spirit and scope of the invention as defined. Thus, the breadth and scope of the present invention should not be limited by any of the above described exemplary embodiments.

What is claimed is:

1. A method for the provision of correct legal citations, comprising:
receiving case information;
receiving citation format information;
accessing a rule set based on said citation format information and said case information;
applying said rule set to said case information;
outputting a correct legal citation as a result of said rule application; and
storing in a database said case information and said correct legal citation for said citation format information.

2. The method of claim 1, wherein said case information is selected from the group comprising: a signal, a first party, a versus, a docket number, a skeletal citation, a reporter volume number, a reporter abbreviation, an initial page, a publishing service, an initial subdivision, an Internet citation, a pinpoint, a reporter table, a first parallel citation, a first parallel pinpoint, a second parallel citation, a second parallel pinpoint, an early American citation, or a court and date of decision.

3. The method of claim 2, wherein said database contains a plurality of linked entries, wherein said linked entries link additional case information and correct legal citations for said additional case information for a given citation format.

4. The method of claim 3, further comprising:
searching said database for said correct legal citations.

5. The method of claim 3, further comprising:
displaying a sorted list of previously outputted correct legal citations.

6. The method of claim 5, wherein said displaying is remote to said database.

7. The method of claim 3, wherein said database contains a collection of at least one of said linked entries, wherein a first user has exclusive access to said collection.

8. The method of claim 7, further comprising:
receiving from a first user a request of access to said collection for a second user; and
sharing said collection with said second user by granting access.

9. A computer readable storage medium having data stored therein representing software executable by a computer, the software including instructions to provide correct legal citations, the storage medium comprising:
instructions for receiving case information;
instructions for receiving citation format information;
instructions for accessing a rule set based on said citation format information and said case information;
instructions for applying said rule set to said case information;
instructions for outputting a correct legal citation as a result of said rule application; and
instructions for storing in a database said case information and said correct legal citation for said citation format information.

10. The computer readable storage medium of claim 9, wherein said case information is selected from the group comprising: a signal, a first party, a versus, a docket number, a skeletal citation, a reporter volume number, a reporter abbreviation, an initial page, a publishing service, an initial subdivision, an Internet citation, a pinpoint, a reporter table, a first parallel citation, a first parallel pinpoint, a second parallel citation, a second parallel pinpoint, an early American citation, or a court and date of decision.

11. The computer readable storage medium of claim 10, wherein said database contains a plurality of linked entries, wherein said linked entries link additional case information and correct legal citations for said additional case information for a given citation format.

12. The computer readable storage medium of claim 11, further comprising:
instructions for searching said database for said correct legal citations.

13. The computer readable storage medium of claim 11, further comprising:
instructions for displaying a sorted list of previously outputted correct legal citations.

14. The computer readable storage medium of claim 13, wherein said displaying is remote to said database.

15. The computer readable storage medium of claim 11, wherein said database contains a collection of at least one of said linked entries, wherein a first user has exclusive access to said collection.

16. The computer readable storage medium of claim 15, further comprising:
instructions for receiving from a first user a request of access to said collection for a second user; and
instructions for sharing said collection with said second user by granting access.
